(19) United States
(12) Patent Application Publication
(10) Pub. No.: US 2020/0311465 A1
(43) Pub. Date: Oct. 1, 2020

(54) CLASSIFICATION OF A POPULATION OF OBJECTS BY CONVOLUTIONAL DICTIONARY LEARNING WITH CLASS PROPORTION DATA

(71) Applicant: miDiagnostics NV, Leuven (BE)

(72) Inventors: Florence YELLIN, Baltimore, MD (US); Benjamin HAEFFELE, Oakland, CA (US); Rene VIDAL, Baltimore, MD (US)

(21) Appl. No.: 16/763,283

(22) PCT Filed: Nov. 14, 2018
(86) PCT No.: PCT/US18/61153

§ 371 Date: May 12, 2020

Related U.S. Application Data
(60) Provisional application No. 62/585,872, filed on Nov. 14, 2017.
(60) Provisional application No. 62/679,757, filed on Jun. 1, 2018.

(51) Int. Cl. G06K 9/62; G01N 15/14; G06K 9/20; G06K 9/00; G03H 1/04; G03H 1/00

(52) U.S. Cl. CPC G06K 9/6202; G01N 15/1475; G06K 9/628; G06K 9/209; G06K 9/00147; G03H 2210/55; G03H 1/0005; G03H 2001/0447; G03H 2226/11; G03H 2001/005; G03H 1/0443

(57) ABSTRACT

A method is disclosed for classifying and/or counting objects (for example, cells) in an image that contains a mixture of several types of objects. Prior statistical information about the object mixtures (class proportion data) is used to improve classification results. The present technique may use a generative model for images containing mixtures of object types to derive a method for classifying and/or counting cells utilizing both class proportion data and classified object templates. The generative model describes an image as the sum of many images with a single cell, where the class of each cell is selected from some statistical distribution. Embodiments of the present techniques have been successfully used to classify white blood cells in images of lysed blood from both normal and abnormal blood donors.

### CROSS-REFERENCE TO RELATED APPLICATIONS

This application claims priority to U.S. Provisional Application Nos. 62/585,872, filed on Nov. 14, 2017, and 62/679,757, filed on Jun. 1, 2018, now pending, the disclosure of which is incorporated herein by reference.

### FIELD OF THE DISCLOSURE

The present disclosure relates to image processing, and in particular object classification and/or counting in images, such as holographic lens-free images.

### BACKGROUND OF THE DISCLOSURE

Many fields benefit from the ability to determine the class of an object, and in particular, the ability to classify and count the objects in an image. For example, object detection and classification in images of biological specimens has many potential applications in diagnosing disease and predicting patient outcome. However, due to the wide range of possible imaging modalities, biological data can potentially suffer from low-resolution images or significant biological variability from patient to patient. Moreover, many state-of-the-art object detection and classification methods in computer vision require large amounts of annotated data for training, but such annotations are often not readily available for biological images, as the annotator must be an expert in the specific type of biological data. Additionally, many state-of-the-art object detection and classification methods are designed for images containing a small number of object instances per class, while biological images can contain thousands of object instances.

One particular application that highlights many of these challenges is holographic lens-free imaging (LFI). LFI is often used in medical applications of microscopy due to its ability to produce images of cells with a large field of view (FOV) with minimal hardware requirements. However, a key challenge is that the resolution of LFI is often low when the FOV is large, making it difficult to detect and classify cells. The task of cell classification is further complicated due to the fact that cell morphologies can also vary dramatically from person to person, especially when disease is involved. Additionally, annotations are typically not available for individual cells in the image, and one might only be able to obtain estimates of the expected proportions of various cell classes via the use of a commercial hematology blood analyzer.

In prior work, LFI images have been used for counting fluorescently labeled white blood cells (WBCs), but not for the more difficult task of classifying WBCs into their various subtypes, e.g., monocytes, lymphocytes, and granulocytes. In previous work, authors have suggested using LFI images of stained WBCs for classification, but they do not provide quantitative classification results. Existing work on WBC classification uses high-resolution images of stained cells from a conventional microscope and attempts to classify cells using hand-crafted features and/or neural networks. However, without staining and/or high resolution images, the cell details (i.e., nucleus and cytoplasm) are not readily visible, making the task of WBC classification significantly more difficult. Furthermore, purely data-driven approaches, such as neural networks, typically require large amounts of annotated data to succeed, which is not available for lens-free images of WBCs.

Accordingly, there is a long-felt need for way to detect, count, and/or classify various subcategories of objects, especially WBCs, e.g. monocytes, lymphocytes, and granulocytes, in reconstructed lens free images, where each image may have hundreds to thousands of instances of each object category and each training image may only be annotated with the expected number of object instances per class in the image. Thus, a key challenge is that there are no bounding box annotations for any object instances.

### BRIEF SUMMARY OF THE DISCLOSURE

The present disclosure provides an improved technique for classifying a population of objects by using class proportion data in addition to object appearance encoded by a template dictionary to better rationalize the resulting classifications of a population of objects. The presently-disclosed techniques may be used to great advantage when classifying blood cells in a blood specimen (or an image of a blood specimen) because the variability in a mixture of blood cells is constrained by physiology. Therefore, statistical information (class proportion data) about blood cell mixtures is used to improve classification results.

In some embodiments, the present disclosure is a method for object classifying a population of at least one object based on a template dictionary and on class proportion data. Class proportion data is obtained, as well as a template dictionary comprising at least one object template of at least one object class. An image is obtained, the image having one or more objects depicted therein. The image may be, for example, a holographic image. A total number of objects in the image is determined. One or more image patches are extracted, each image patch containing a corresponding object of the image. The method includes determining a class of each object based on a strength of match of the corresponding image patch to each object template and influenced by the class proportion data.

In some embodiments, a system for classifying objects in a specimen and/or an image of a specimen is provided. The system may include a chamber for holding at least a portion of the specimen. The chamber may be, for example, a flow chamber. A lens-free image sensor is provided for obtaining a holographic image of the portion of the specimen in the chamber. The image sensor may be, for example, an active pixel sensor, a CCD, a CMOS active pixel sensor, etc. In some embodiments, the system further includes a coherent light source. A processor is in communication with the image sensor. The processor is programmed to perform any of the methods of the present disclosure. For example, the processor may be programmed to obtain a holographic image having one or more objects depicted therein; determine a total number of objects in the image; obtain class proportion data and a template dictionary comprising at least one object template of at least one object class; extract one or more image patches, each image patch containing a corresponding object of the image; and determine a class of each object based on a strength of match of the corresponding image patch to each object template and influenced by the class proportion data.

In some embodiments, the present disclosure is a non-transitory computer-readable medium having stored thereon a computer program for instructing a computer to perform any of the methods disclosed herein. For example, the medium may include instructions to obtain a holographic image having one or more objects depicted therein; determine a total number of objects in the image; obtain class proportion data and a template dictionary comprising at least one object template of at least one object class; extract one or more image patches, each image patch containing a corresponding object of the image; and determine a class of each object based on a strength of match of the corresponding image patch to each object template and influenced by the class proportion data.

In some embodiments, the disclosure provides a probabilistic generative model of an image. Conditioned on the total number of objects, the model generates the number of object instances for each class according to a prior model for the class proportions. Then, for each object instance, the model generates the object's location as well as a convolutional template describing the object's appearance. An image may then be generated as the superposition of the convolutional templates associated with all object instances.

Given the model parameters, we show that the problem of detecting, counting and classifying object instances in new images can be formulated as an extension of the convolutional sparse coding problem, which can be solved in a greedy manner, similar to that shown in PCT/US2017/059933. However, unlike the method disclosed in the reference, the present generative model utilizes class proportion priors, which greatly enhances the ability to jointly classify multiple object instances, in addition to providing a principled stopping criteria for determining the number of objects for the greedy method. The present disclosure also addresses the problem of learning the model parameters from known cell type proportions, which are formulated as an extension of convolutional dictionary learning with priors on class proportions.

An exemplary embodiment of the presently-disclosed convolutional sparse coding method with class proportion priors was evaluated on lens-free imaging (LFI) images of human blood samples. The experiments for the task of estimating the proportions of WBCs show that the present method clearly outperforms not only standard convolutional sparse coding but also support vector machines and convolutional neural networks. Furthermore, the present method was tested on blood samples from both healthy donors and donors with abnormal WBC concentrations due to various pathologies which are rare events in the prior model, demonstrating that the method is able to provide promising results across a wide range of biological variability and for cases that are not likely a priori under a prior model.

### DESCRIPTION OF THE DRAWINGS

For a fuller understanding of the nature and objects of the disclosure, reference should be made to the following detailed description taken in conjunction with the accompanying drawings, in which:

FIG. 1 is a method according to an embodiment of the present disclosure;

FIG. 2 is a system according to another embodiment of the present disclosure;

FIG. 3A is an exemplary image of white blood cells containing a mixture of granulocytes, lymphocytes, and monocytes;

FIG. 3B is a magnified view of the region of FIG. 3A identified by a white box, which represents a typical region where cells belonging to different classes are sparsely distributed;

FIG. 4 shows an exemplary set of learned templates of white blood cells, wherein each template belongs to either the granulocyte (in the top region), lymphocyte (middle region), or monocyte (bottom region) class of white blood cells;

FIG. 5 is a chart showing the histograms of class proportions for three classes for white blood cells—granulocytes, lymphocytes, and monocytes—where the histograms were obtained from complete blood count (CBC) results of 300,000 patients; and

FIG. 6 is a set of charts for a three-part differential (i.e., classification) for 36 lysed blood cell samples, wherein the charts of the left column show the presently-disclosed method compared to results extrapolated from a standard hematology analyzer, and the charts of the right column show results of a variation of the present technique without using class proportion data (i.e., λ=0) compared to the results extrapolated from the hematology analyzer (data was obtained from both normal and abnormal donors).

FIG. 7A is an exemplary image of WBCs containing a mixture of granulocytes, lymphocytes, and monocytes, in addition to lysed red blood cell debris.

FIG. 7B shows a zoomed-in view of the detail bounded in the box of FIG. 7A, which is a typical region of the image, wherein cells belonging to different classes are sparsely distributed.

FIG. 8 is a diagram showing generative model dependencies for an image.

FIG. 9A is a graph demonstrating that the greedy cell counting scheme stops at the minimum of f(N).

FIG. 9B is a graph demonstrating the stopping condition is class dependent. Only two WBC classes, lymphocytes (lymph.) and granulocytes (gran.), are shown for ease of visualization. The stopping condition is the right hand side of Equation 20 below, and the squared coefficients are α². Both classes reach their stopping condition at around the same iteration, despite having different coefficient values.

FIGS. 10A-10C show exemplary learned templates of WBCs, wherein each template belongs to either the granulocyte (FIG. 10A), lymphocyte (FIG. 10B), or monocyte (FIG. 10C) class of WBCs.

FIGS. 10D-10E show statistical training data obtained from the CBC dataset. The overlaid histograms of class proportions (FIG. 10D) show that most patients have many more granulocytes than monocytes or lymphocytes. Notice that the histogram of concentrations of WBCs (FIG. 10E) has a long tail.

FIG. 11A is an enlarged portion of an image showing an overlay with detections and classifications produced by an embodiment of the presently-disclosed method.

FIG. 11B shows a graph of the results of cell counting. Cell counts estimated by various methods are compared to results extrapolated from a hematology analyzer. The methods shown are thresholding (light shade), CSC without priors (black) and the present method (medium shade). Results are shown for 20 normal blood donors (x) and 12 abnormal clinical discards (∘).

FIG. 12 The percentages of granulocytes (medium shade), lymphocytes (black), and monocytes (lightest shade) predicted by various methods are compared to results from a hematology analyzer. The methods are: SVM on patches extracted from images via thresholding (top left), CSC without statistical priors (top right), CNN on patches extracted from images via thresholding (bottom left), and the presently-disclosed method (bottom right). Results are shown for 20 normal blood donors (x) and 12 abnormal clinical discards (∘).

### DETAILED DESCRIPTION OF THE DISCLOSURE

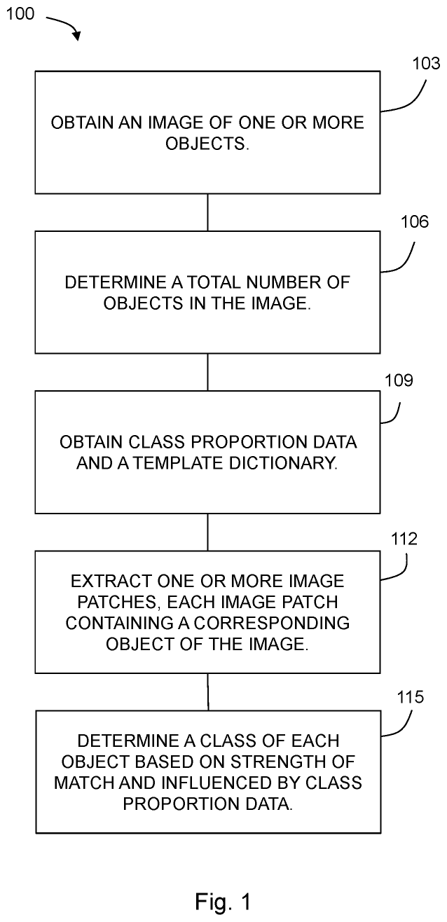

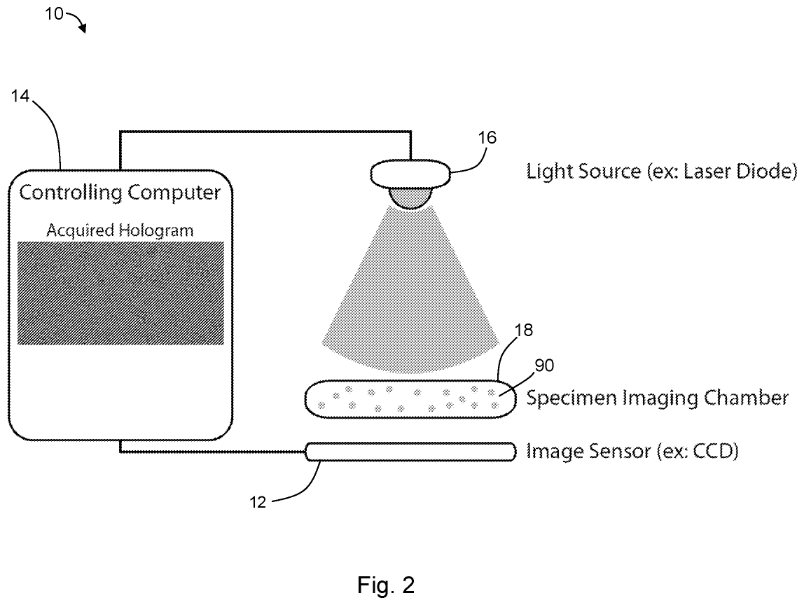

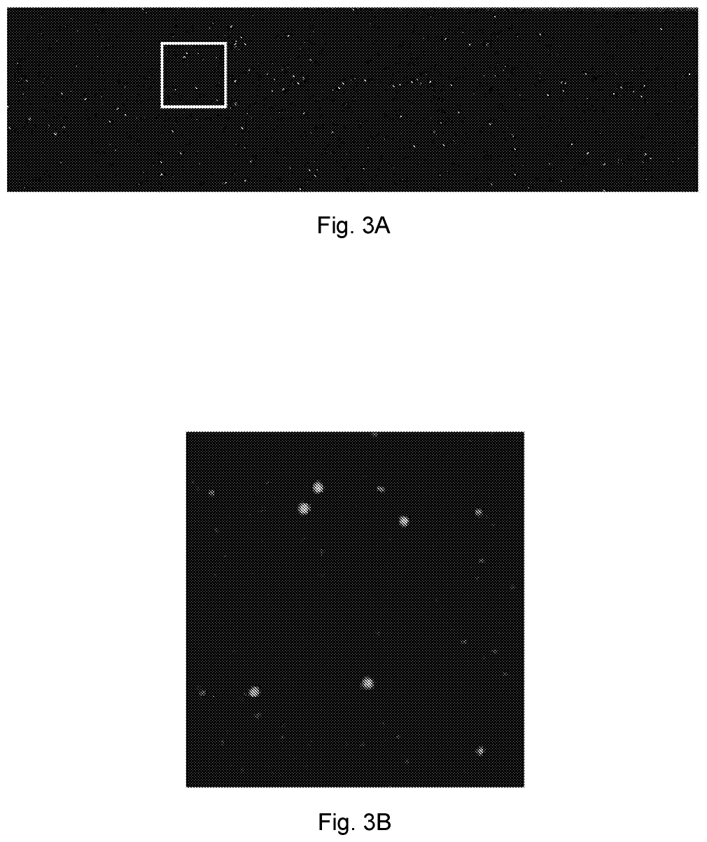

With reference to FIG. 1, the present disclosure may be embodied as a method 100 for object classification using a template dictionary and class proportion data. A template dictionary may be learned, for example, using convolutional dictionary learning as disclosed in International application no. PCT/US2017/059933, the disclosure of which is incorporated herein by this reference. Class proportion data may be, for example, information regarding an expected distribution of object types amongst a given set of classes for a population. For example, class proportion data for classifying white blood cells in an image of a blood specimen may include information on an expected distribution of cell types in the image e.g., the expected percentages of monocytes, lymphocytes, and granulocytes. In some embodiments, the method 100 may be used for classifying objects in an image, such as, for example, a holographic image. In an illustrative example, the method 100 can be used for classifying types of cells in a specimen, for example, types of white blood cells in a specimen of blood. The method 100 includes obtaining 103 an image having one or more objects depicted therein. An exemplary image is shown in FIGS. 3A and 3B. The obtained 103 image may be a traditional 2D image, a holographic image, or a 3D image or representation of a 3D image, such as, for example, a 3D stack of images captured using confocal or multiphoton microscopy, etc.

A total number (N) of objects in the image is determined 106. For example, using the illustrative example of white blood cells in a blood specimen, the total number of white blood cells depicted in the image is determined 106. The number of objects may be determined 106 in any way suitable to the image at hand. For example, the objects may be detected and counted using convolutional dictionary learning as disclosed in U.S. patent application No. 62/417,720. Other techniques for counting objects in an image are known and may be used within the scope of the present disclosure—for example, edge detection, blob detection, Hough transform, etc.

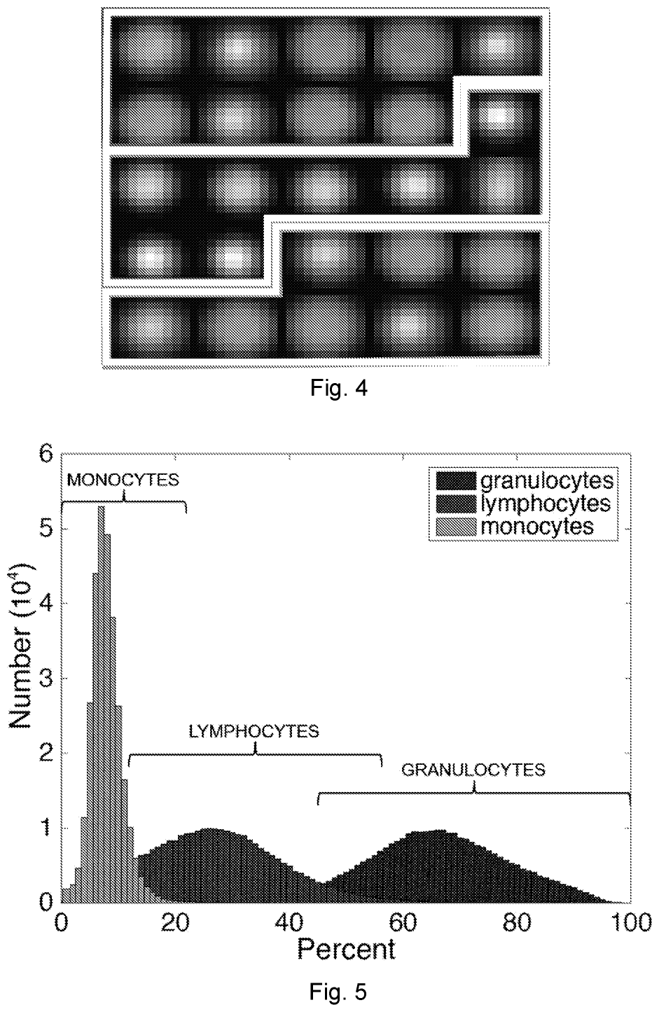

The method 100 includes obtaining 109 class proportion data and a template dictionary having at least one object template in at least one class. For example, the template dictionary may have a plurality of object templates in a total of, for example, five classes, such that each object template is classified into one of the five classes. Using the above illustrative example of a blood specimen, the template dictionary may comprise a plurality of object templates, each classified as either a monocyte, a lymphocyte, or a granulocyte. Each object template is an image of a known object. More than one object template can be used and the use of a greater number of object templates in a template dictionary may improve object classification. For example, each object template may be a unique (amongst the object templates) representation of the object to be detected, for example, a representation of the object in a different orientation of the object, morphology, etc. In embodiments, the number of object templates may be 2, 3, 4, 5, 6, 10, 20, 50, or more, including all integer number of objects therebetween. FIG. 4 shows an exemplary template dictionary having a total of 25 object templates, wherein the top nine object templates are classified as granulocytes, the middle eight are lymphocytes, and the bottom eight are monocytes. Multiple templates for each class may be beneficial to account for potential variability in the appearances of objects in a class due to, for example (using cells as an example), orientation, disease, or biological variation. The class proportion data is data regarding the distribution of objects in the classes in a known population. Each of the template dictionary and class proportion data may be determined a priori.

The method 100 further includes extracting 112 one or more image patches (one or more subsets of the image) each image patch of the one or more image patches containing a corresponding object of the image. Each extracted 112 image patch is that portion of the image which includes the respective object. Patch size may be selected to be approximately the same size as the objects of interest within the image. For example, the patch size may be selected to be at least as large as the largest object of interest with the image. Patches can be any size; for example, patches may be 3, 10, 15, 20, 30, 50, or 100 pixels in length and/or width, or any integer value therebetween, or larger. As further described below under the heading “Further Discussion,” a class of each object is determined 115 based on a strength of match between the corresponding image patch and each object template in the template dictionary and influenced by the class proportion data.

In another aspect, the present disclosure may be embodied as a system 10 for classifying objects in a specimen and/or an image of a specimen. The specimen 90 may be, for example, a fluid. In other examples, the specimen is a biological tissue or other solid specimen. The system 10 comprises a chamber 18 for holding at least a portion of the specimen 90. In the example where the specimen is a fluid, the chamber 18 may be a portion of a flow path through which the fluid is moved. For example, the fluid may be moved through a tube or micro-fluidic channel, and the chamber 18 is a portion of the tube or channel in which the objects will be counted. Using the example of a specimen which is a tissue, the chamber may be, for example, a microscope slide.

The system 10 may have an image sensor 12 for obtaining images. The image sensor 12 may be, for example, an active pixel sensor, a charge-coupled device (CCD), or a CMOS active pixel sensor. In some embodiments, the image sensor 12 is a lens-free image sensor for obtaining holographic images. The system 10 may further include a light source 16, such as a coherent light source. The image sensor 12 is configured to obtain an image of the portion of the fluid in the chamber 18, illuminated by light from the light source 16, when the image sensor 12 is actuated. In embodiments having a lens-free image sensor, the image sensor 12 is configured to obtain a holographic image. A processor 14 may be in communication with the image sensor 12.

The processor 14 may be programmed to perform any of the methods of the present disclosure. For example, the processor 14 may be programmed to obtain an image (in some cases, a holographic image) of the specimen in the chamber 18. The processor 14 may obtain class proportion data and a template dictionary. The processor 14 may be programmed to determine a total number of objects in the image, and extract one or more image patches, each image patch containing a corresponding object. The processor 14 determines a class of each object based on a strength of match of the corresponding image patch to each object template and influenced by the class proportion data. In an example of obtaining an image, the processor 14 may be programmed to cause the image sensor 12 to capture an image of the specimen in the chamber 18, and the processor 14 may then obtain the captured image from the image sensor 12. In another example, the processor 14 may obtain the image from a storage device.

The processor may be in communication with and/or include a memory. The memory can be, for example, a Random-Access Memory (RAM) (e.g., a dynamic RAM, a static RAM), a flash memory, a removable memory, and/or so forth. In some instances, instructions associated with performing the operations described herein (e.g., operate an image sensor, generate a reconstructed image) can be stored within the memory and/or a storage medium (which, in some embodiments, includes a database in which the instructions are stored) and the instructions are executed at the processor.

In some instances, the processor includes one or more modules and/or components. Each module/component executed by the processor can be any combination of hardware-based module/component (e.g., a field-programmable gate array (FPGA), an application specific integrated circuit (ASIC), a digital signal processor (DSP)), software-based module (e.g., a module of computer code stored in the memory and/or in the database, and/or executed at the processor), and/or a combination of hardware- and software-based modules. Each module/component executed by the processor is capable of performing one or more specific functions/operations as described herein. In some instances, the modules/components included and executed in the processor can be, for example, a process, application, virtual machine, and/or some other hardware or software module/component. The processor can be any suitable processor configured to run and/or execute those modules/components. The processor can be any suitable processing device configured to run and/or execute a set of instructions or code. For example, the processor can be a general purpose processor, a central processing unit (CPU), an accelerated processing unit (APU), a field-programmable gate array (FPGA), an application specific integrated circuit (ASIC), a digital signal processor (DSP), and/or the like.

Some instances described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other instances described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, instances may be implemented using Java, C++, .NET, or other programming languages (e.g., object-oriented programming languages) and development tools. Additional examples of computer code include, but are not limited to, control signals, encrypted code, and compressed code.

In an exemplary application, the methods or systems of the present disclosure may be used to detect and/or count objects within a biological specimen. For example, an embodiment of the system may be used to count red blood cells and/or white blood cells in whole blood. In such an embodiment, the object template(s) may be representations of red blood cells and/or white blood cells in one or more orientations. In some embodiments, the biological specimen may be processed before use with the presently-disclosed techniques.

In another aspect, the present disclosure may be embodied as a non-transitory computer-readable medium having stored thereon a computer program for instructing a computer to perform any of the methods disclosed herein. For example, a non-transitory computer-readable medium may include a computer program to obtain an image, such as a holographic image, having one or more objects depicted therein; determine a total number of objects in the image; obtain class proportion data and a template dictionary comprising at least one object template of at least one object class; extract one or more image patches, each image patch containing a corresponding object of the image; and determine a class of each object based on a strength of match of the corresponding image patch to each object template and influenced by the class proportion data.

### Further Discussion 1

For convenience, the following discussion is based on a first illustrative example of classifying cells of a blood specimen. The example is not intended to be limiting and can be extended to classifying other types of objects.

### Problem Formulation

Let I be an observed image of a mixture of cells, where each cell belongs to one of C distinct cell classes. Assume that there are {n_{c}}_{c=1}^{C} cells of each class in the image, and the total number of cells in the image is N=Σ_{c}n_{c}. The number of cells per class, the total number of cells, the class of each cell {sᵢ}ᵢ₌₁^{N}, and the locations {xᵢ, yᵢ}ᵢ₌₁^{N} of the cells in the image are all unknown. However, the distribution of the classes is known to follow some statistical distribution. Assume this distribution is a multinomial distribution, so that the probability that the cells in the image are in classes cell {sᵢ}ᵢ₌₁^{N}, given that there are N cells in the image, can be expressed as:

$$p ( {s}_{1} , {s}_{2} , … , {s}_{N} \vert N ) ∝ {\prod }_{c = 1}^{C} {( {p}_{c \vert N} )}^{{n}_{c}} , \qquad ( 1 )$$

where p_{c|N} is the probability that a cell is in class c, given that there are N cells. Suppose K cell templates {dₖ}ₖ₌₁^{K} are provided, where the cell templates capture the variation among all classes of cells and each template describes cells belonging to a single, known class. The cell templates can be used to decompose the image containing N cells into the sum of N images, each containing a single cell. Specifically, the image can be expressed as:

$$I ( x , y ) = {\sum }_{i = 1}^{N} {α}_{i} {d}_{{k}_{i}} ( x , y ) ★ {δ}_{{x}_{i} , {y}_{i}} + ϵ , \qquad ( 2 )$$

where δₓ_{ᵢ}_{,y}_{ᵢ} is shorthand for δ(x−xᵢ, y−yᵢ), ★ is the 2D convolution operator, and ϵ is Gaussian noise. The coefficient αᵢ describes how well the template dₖ_{ᵢ} represents the i^{th} cell, and class (kᵢ)=sᵢ. Finally, assume that the noise is zero mean with standard deviation σₗ, so that the probability of generating an image I, given that there are N cells at locations {xᵢ,yᵢ}ᵢ₌₁^{N} described by templates {kᵢ}ᵢ₌₁^{N} with strengths {αᵢ}ᵢ₌₁^{N} can be expressed as:

$$p ( I \vert {k}_{1} , {α}_{1} , {x}_{1} , {y}_{1} , … , {k}_{N} , {α}_{N} , {x}_{N} , {y}_{N} , N ) = \frac{1}{{( 2 {σ}_{I}^{2} )}^{d}} exp ( - \frac{{‖ I - {\sum }_{i = 1}^{N} {d}_{{k}_{i}} ★ {α}_{i} {δ}_{{x}_{i} , {y}_{i}} ‖}_{F}^{2}}{2 {σ}_{I}^{2}} ) \qquad ( 3 )$$

where d is the size of the image.

### Classification by Convolutional Dictionary Learning with Class Proportion Data

Assume for now that the number of cells in an image, the location of each cell, and a set of templates describing each class of cells are known. Given an image I, a goal is to find the class {sᵢ}ᵢ₌₁^{N} of each cell. The template {kᵢ}ᵢ₌₁^{N} that best approximate each cell is found. Once the template that best approximates the i^{th} cell is known, the class is assigned as:

sᵢ=class(kᵢ) (4)

As a byproduct of determining the template that best approximates a cell, a strength of match (αᵢ) between the cell and the template. Using the generative model described above, the problem can be formulated as:

$${min}_{\{ {k}_{i} , {α}_{i} \}} {‖ I - {\sum }_{i = 1}^{N} {d}_{{k}_{i}} ★ {α}_{i} {δ}_{{x}_{i} , {y}_{i}} ‖}_{F}^{2} - λ {\sum }_{c = 1}^{C} {n}_{c} log {p}_{c \vert N} \qquad ( 5 )$$

where λ is a hyper-parameter of the model that controls the tradeoff between the reconstructive (first) term and the class proportion prior (second) term. Notice that the two terms are coupled, because n_{c}=Σᵢ₌₁^{N}(class(kᵢ)=c), where 1(⋅) is the indicator function that is 1 if its argument is true and 0 otherwise.

To simplify this problem, it can be assumed that cells do not overlap. In some embodiments, this assumption is justified, because the cells of such embodiments are located in a single plane, and two cells cannot occupy the same space. In other embodiments, the sparsity of cells makes it unlikely that cells will overlap. The non-overlapping assumption allows the equations to be rewritten as:

$${‖ I - {\sum }_{i = 1}^{N} {d}_{{k}_{i}} ★ {α}_{i} {δ}_{{x}_{i} , {y}_{i}} ‖}_{F}^{2} \approx {\sum }_{i = 1}^{N} {‖ {e}_{i} - {α}_{i} {d}_{{k}_{i}} ‖}_{2}^{2} \qquad ( 6 )$$

where eᵢ is a patch (the same size as the templates) extracted from I centered at (xᵢ, yᵢ).

For fixed kᵢ, the problem is quadratic in αᵢ. Assuming the templates are normalized so that dₖ^{T}dₖ=1 for all k, the solution for the i^{th} coefficient is αᵢ(kᵢ)=dₖ_{ᵢ}^{T}eᵢ. Plugging this into Equation 5, it can be shown that the solution for the template that best approximates the i^{th} cell is:

$${k}_{i} = {arg max }_{j ∈ 1 : K} [ {( {d}_{j}^{T} {e}_{i} )}^{2} + λ {\sum }_{c = 1}^{C} 1 ( class ( {d}_{j} ) = c ) log {p}_{c \vert N} ] \qquad ( 7 )$$

### Training Cell Templates

Now consider the problem of learning the templates {dₖ}ₖ₌₁^{K}. To learn templates for each of the C cell classes, it is desirable to have images for which the ground truth classes are known. For the exemplary white blood cell images, it was not possible to obtain ground truth classifications for individual cells in the mixed population images. Therefore, the cell templates were trained using images that contain only a single class of cells. In accordance with the generative model, the problem is formulated as:

$${min}_{\{ {d}_{{k}_{i}} , {x}_{i} , {y}_{i} {k}_{i} {α}_{i} \}} {‖ I - {\sum }_{i = 1}^{N} {d}_{{k}_{i}} ★ {α}_{i} {δ}_{{x}_{i} , {y}_{i}} ‖}_{F}^{2} \\ such that {‖ {d}_{k} ‖}_{2} = 1 for all k \qquad ( 8 )$$

where the constraint ensures that the problem is well-posed. Because all cells in the training images belong to the same class, which is known a priori, the second term in Equation 5 is not relevant during object template training. The templates from the training images of single cell populations were learned using the convolution dictionary learning and encoding method described in U.S. patent application No. 62/417,720. To obtain the complete set of K templates, the templates learned from each of the C classes are concatenated.

### Learning Class Proportion Probabilities

A multinomial distribution is proposed herein to describe the proportions of cells in an image, and the probability that a cell belongs to a class is assumed to be independent of the number of cells in the image, or p_{c|N}=p_{c}. This simple model was found to work well for the exemplary application of classifying white blood cells in images of lysed blood, but the presently disclosed method of classification by convolutional dictionary learning with class proportion priors can be extended to allow for more complex distributions. To learn the prior class proportions p_{c} for the types of blood cells observed in the images of the illustrative embodiment, a database of complete blood count (CBC) results from almost 300,000 patients at the Johns Hopkins hospitals was used. Each CBC results contains the number of blood cells {n_{c}}_{c=1}^{C} (per unit volume) belonging to each class of white blood cells, as well as the total number of white blood cells N (per unit volume) in the blood sample. The prior proportion p_{c} for class c is the mean class proportion [symbol] n_{c}/N [symbol] over all CBC results. The histograms of class proportions from the CBC database are shown in FIG. 5.

### Cell Detection and Counting

Recall that the number of objects is determined as a step (finding N) in the present technique and the location of each object is found (finding {xᵢ, yᵢ} such that the image patch can be extracted. Rather than jointly optimizing over {kᵢ, αᵢ, xᵢ, yᵢ} and N, any fast object detection method can be used to compute {xᵢ, yᵢ} and N with the input images, e.g., thresholding or convolutional dictionary encoding, etc. The relevant patches may then be extracted for use in the currently described method.

### Results of the Illustrative Embodiment

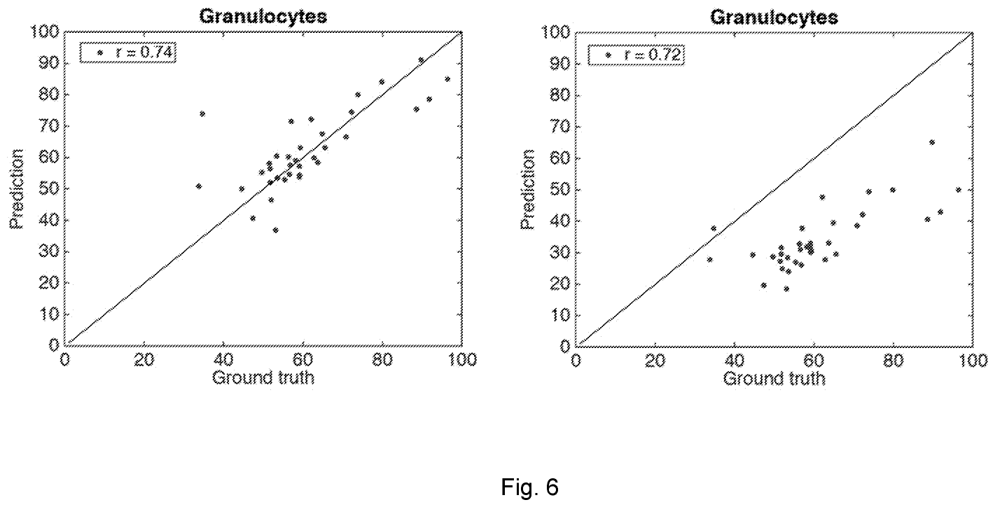

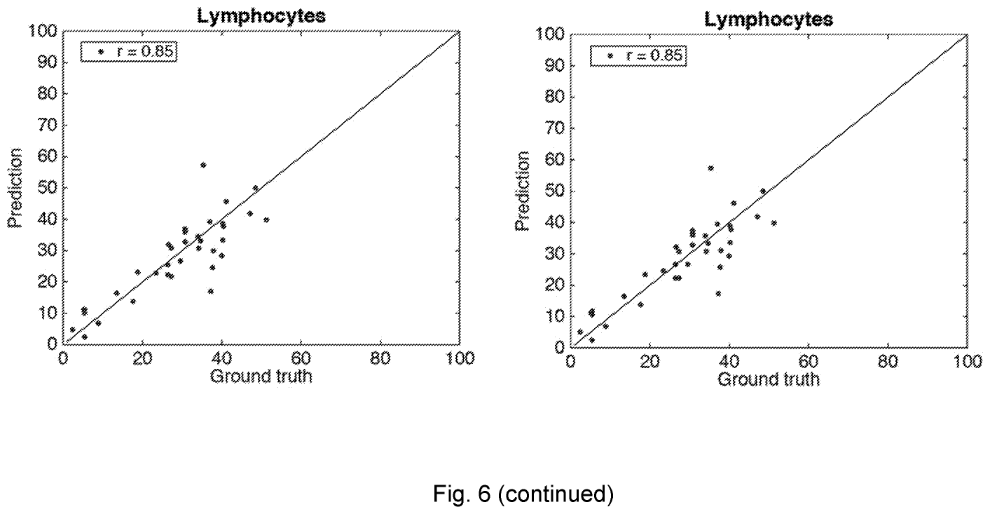

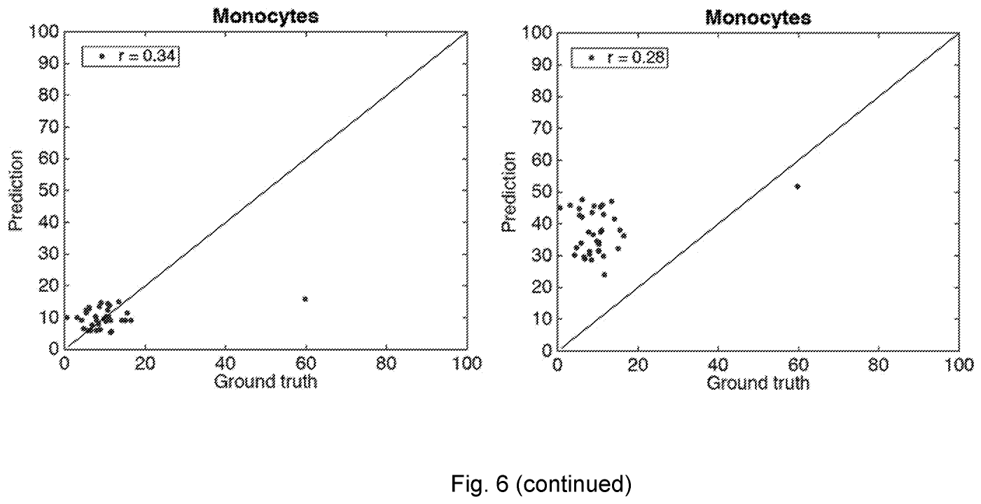

This disclosed technique was tested using reconstructed holographic images of lysed blood. The lysed blood contained three types of white blood cells: granulocytes, lymphocytes, and monocytes. Given an image containing a mixture of white blood cells, the goal was to classify each cell in the image. FIG. 6 shows the predicted class proportions compared to the ground truth proportions for 36 lysed blood samples (left column). Ground truth proportions were extrapolated from a standard hematology analyzer, and blood samples were obtained from both normal and abnormal donors. The figure shows a good correlation between the predictions and ground truth for granulocytes and lymphocytes. For monocytes the correlation was not as good, but the absolute error between the predicted and ground truth proportion was still very small, with the exception of one outlier. The results obtained without using class proportion data are show for comparison as well (right column). For the easier to distinguish class of lymphocytes, results were comparable with and without class proportion data, but for the more difficult cases of classifying granulocytes and monocytes, the prior term significantly reduced the classification error.

### Further Discussion 2

For convenience, the following discussion is based on a second illustrative example of classifying cells of a blood specimen. The example is not intended to be limiting and can be extended to classifying other types of objects.

### Generative Model for Cell Images

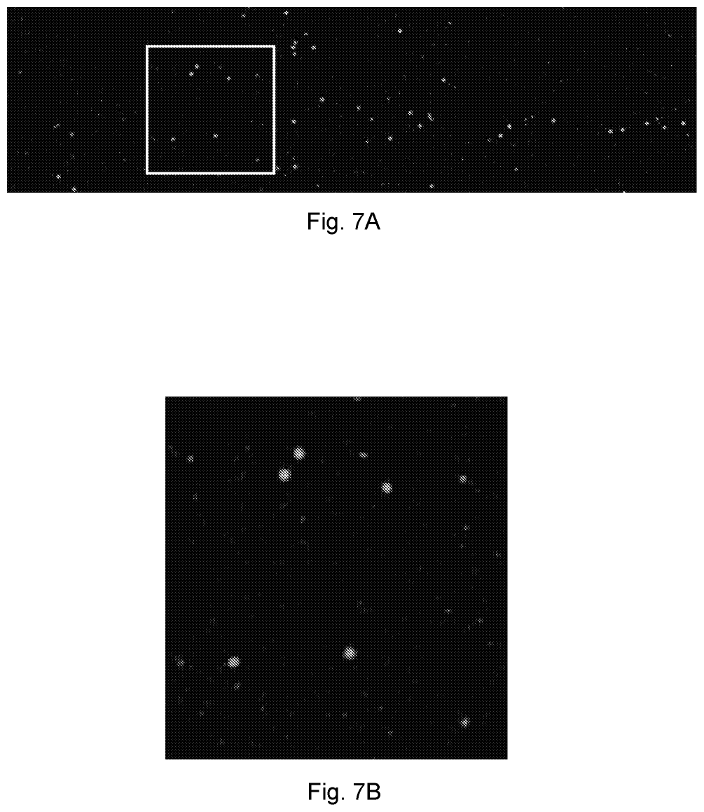

Let I be an observed image containing N WBCs, where each cell belongs to one of C distinct classes. Cells from all classes are described by a collection of K class templates {dₖ}ₖ₌₁^{K} that describe the variability of cells within each class. FIG. 7A shows a typical LFI image of human blood diluted in a lysing solution that causes the red blood cells to break apart, leaving predominately just WBCs and red blood cell debris. Note that the cells are relatively spread out in space, so it is assumed that each cell does not overlap with a neighboring cell and that a cell can be well approximated by a single cell template, each one corresponding to a single, known class. The cell templates can thus be used to decompose the image containing N cells into the sum of N images, each containing a single cell. Specifically, the image intensity at pixel (x, y) is generated as:

$$I ( x , y ) = {\sum }_{i = 1}^{N} {α}_{i} [ {d}_{{k}_{i}} ★ {δ}_{{x}_{i} , {y}_{i}} ] ( x , y ) + ϵ ( x , y ) , \qquad ( 9 )$$

where (xᵢ, yᵢ) denotes the location of the i^{th} cell, is shorthand for δ(x−xᵢ, y−yᵢ), ★ is the 2D convolution operator, kᵢ denotes the index of the template associated with the i^{th} cell, the coefficient αᵢ scales the template dₖ_{ᵢ} to represent the i^{th} cell, and the noise ϵ(x, y)˜N(0, σ_{I}²) is assumed to be an independent and identically distributed zero-mean Gaussian noise with standard deviation αᵢ at each pixel (x, y). Under this model, the probability of generating an image I, given that there are N cells at locations x={xᵢ, yᵢ}ᵢ₌₁^{N} described by K templates with indices k={kᵢ}ᵢ₌₁^{N}, and strengths α={αᵢ}ᵢ₌₁^{N} is given by the multivariate Gaussian:

$$p ( I \vert k , α , x , N ) = {( 2 {πσ}_{I}^{2} )}^{- \frac{{P}_{I}}{2}} exp ( - \frac{{‖ I - {\sum }_{i = 1}^{N} {α}_{i} {d}_{{k}_{i}} ⋆ {δ}_{{x}_{i} , {y}_{i}} ‖}_{F}^{2}}{2 {σ}_{I}^{2}} ) , \qquad ( 10 )$$

where P_{I} denotes the number of pixels in image I.

To complete the model, we define a prior for the distribution of the cells in the image p(k, α, x, N). To that end, we assume that the template indices, strengths, and locations are independent given N, i.e.,

p(k,α,x,N)=p(k|N)p(α|N)p(x|N)p(N). (11)

Therefore, to define the prior model, we define each one of the terms in the right hand side of (11). Note that this assumption of conditional independence makes sense when the cells are of similar scale and the illumination conditions are relatively uniform across the FOV, as is the case for our data.

To define the prior model on template indices, each template dₖ is modeled as corresponding to one of the C classes, denoted as class(k). Therefore, given kᵢ and N, the class sᵢ of the i^{th} cell is a deterministic function of the template index, sᵢ=class(kᵢ). Next, we assume that all templates associated with one class are equally likely to describe a cell from that class. That is, we assume that the prior distribution of the template given the class is uniform, i.e.,

$$p ( {k}_{i} \vert {s}_{i} ) = \frac{1 ( class ( {k}_{i} ) = {s}_{i} )}{{t}_{{s}_{i}}} , \qquad ( 12 )$$

where t_{c}, is the number of templates for class c. We then assume that the prior probability that a cell belongs to a class is independent of the number of cells in the image, i.e., p(sᵢ=c|N)=p(sᵢ=c). Here we denote the probability of a cell belonging to class c as:

p(sᵢ=c)=μ_{c}, (13)

where Σ_{c=1}^{C}μ_{c}=1. Next, we assume that the classes of each cell are independent from each other and thus the joint probability of all cells being described by templates k and belonging to classes s={sᵢ}ᵢ₌₁^{N} can be expressed as:

$$\begin{matrix}p ( k , s \vert N ) = {\prod }_{i = 1}^{N} p ( {k}_{i} \vert {s}_{i} ) p ( {s}_{i} ) \\ = {\prod }_{i = 1}^{N} \frac{{μ}_{{s}_{i}}}{{t}_{{s}_{i}}} 1 ( class ( {k}_{i} ) = {s}_{i} ) \\ = {\prod }_{c = 1}^{c} {( \frac{{μ}_{c}}{{t}_{c}} )}^{{n}_{c}} 1 ( class ( k ) = s ) ,\end{matrix} \qquad ( 14 )$$

where n_{c}=Σᵢ₌₁^{N}1(sᵢ=c) is the number of cells in class c. The above equation, together with the constraint class(k)=s, completes the definition of p(k|N) as:

$$p ( k \vert N ) = {\prod }_{i = 1}^{N} \frac{{μ}_{class ( {k}_{i} )}}{{t}_{class ( {k}_{i} )}} . \qquad ( 15 )$$

To define the prior on the strengths of the cell detections, α, we assume that they are independent and exponentially distributed with parameter 72 ,

$$p ( α \vert N ) = \frac{1}{{η}^{N}} exp ( \frac{- {\sum }_{i = 1}^{N} {α}_{i}}{η} ) , \qquad ( 16 )$$

and we note that this is the maximum entropy distribution for the detections under the assumption that the detection parameter is positive and has mean η.

To define the prior on the distribution of the cell locations, we assume a uniform distribution in space, i.e.,

$$p ( x \vert N ) = {\prod }_{i = 1}^{N} \frac{1}{{P}_{I}} = \frac{1}{{P}_{I}^{N}} . \qquad ( 17 )$$

To define the prior on the number of cells in the image, we assume a Poisson distribution with mean λ, i.e.,

$$p ( N ) = {e}^{- λ} \frac{{λ}^{N}}{N !} \qquad ( 18 )$$

Both assumptions are adequate because the imaged cells are diluted, in suspension and not interacting with each other.

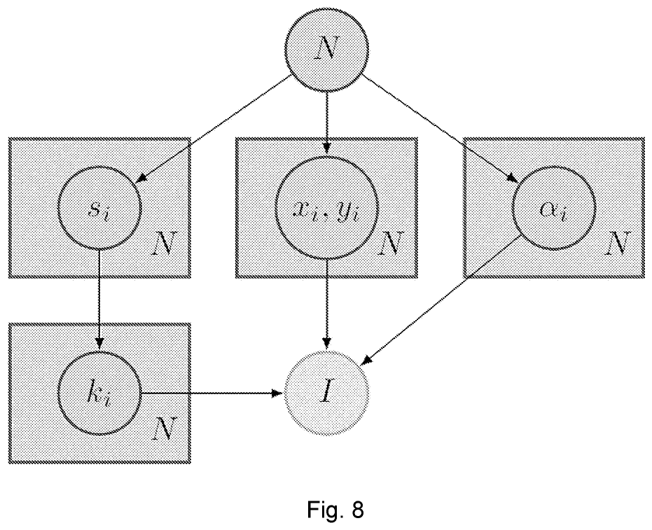

In summary, the joint distribution of all the variables of the generative model (see FIG. 8 for dependencies among variables) can be written as follows:

$$\begin{matrix}p ( I , k , α , x , N ) = p ( I \vert k , α , x , N ) p ( k \vert N ) p ( α \vert N ) \\ p ( x \vert N ) p ( N ) \\ = \frac{{λ}^{N}}{{{e}^{λ} ( 2 {πσ}_{I}^{2} )}^{\frac{{P}_{I}}{2}} {( {P}_{I} η )}^{N} N !} exp ( \frac{- {\sum }_{i = 1}^{N} {α}_{i}}{η} ) \\ exp ( - \frac{{‖ I - {\sum }_{i = 1}^{N} {α}_{i} {d}_{{k}_{i}} {★δ}_{{x}_{i} , {y}_{i}} ‖}_{F}^{2}}{2 {σ}_{I}^{2}} ) \\ {\prod }_{i = 1}^{N} \frac{{μ}_{class ( {k}_{i} )}}{{t}_{class ( {k}_{i} )}} .\end{matrix} \qquad ( 19 )$$

### Inference for Cell Detection, Classification, and Counting

Given an image, we detect, count, and classify all the cells and then predict cell proportions. In order to do this inference task, we maximize the log likelihood,

$$\begin{matrix}( k , α , x , N ) = {arg max}_{k , α , x , N} p ( k , α , x , N \vert I ) \\ = {arg max}_{k , α , x , N} log p ( I , k , α , x , N ) .\end{matrix} \qquad ( 20 )$$

Assuming the parameters of the modeled distributions are known, the inference problem is equivalent to:

$${min}_{k , α > 0 , x , N} [ \frac{{‖ I - {\sum }_{i = 1}^{N} {α}_{i} {d}_{{k}_{i}} {★δ}_{{x}_{i} , {y}_{i}} ‖}_{F}^{2}}{2 {σ}_{I}^{2}} + \frac{1}{η} {\sum }_{i = 1}^{N} {α}_{i} - {\sum }_{i = 1}^{N} log ( \frac{{μ}_{class ( {k}_{i} )}}{{t}_{class ( {k}_{i} )}} ) + N log ( \frac{η {P}_{I}}{λ} ) + log ( N ! ) ] . \qquad ( 21 )$$

### Cell Detection and Classification

Assume for now that the number of cells N in an image is known. To perform cell detection and classification, we would like to solve the inference problem in Equation (21) over x, k, and α. Rather than solving for all N cell detections and classifications in one iteration, we employ a greedy method that uses N iterations, in which each iteration solves for a single cell detection and classification.

We begin by defining the residual image at iteration i as:

$${R}_{i} = I - {\sum }_{j = 1}^{i} {α}_{j} {d}_{{k}_{j}} {★δ}_{{x}_{j} , {y}_{j}} . \qquad ( 22 )$$

Initially, the residual image is equal to the input image, and as each cell is detected, its approximation is removed from the residual image. At each iteration, the optimization problem for x, k, and α can be expressed in terms of the residual as:

$${min}_{{x}_{i} , {y}_{i} , {α}_{i} > 0 , {k}_{i}} [ {‖ {R}_{i - 1} - {d}_{{k}_{i}} {★α}_{i} {δ}_{{x}_{i} , {y}_{i}} ‖}_{F}^{2} + \frac{2 {σ}_{I}^{2}}{η} {α}_{i} - 2 {σ}_{I}^{2} log ( \frac{{μ}_{class ( {k}_{i} )}}{{t}_{class ( {k}_{i} )}} ) ] . \qquad ( 23 )$$

Given xᵢ, yᵢ, and kᵢ, the solution for \hat{α}ᵢ is given by:

$${\hat{α}}_{i} = \frac{{\frac{{σ}_{I}^{2}}{η}}_{} ( ( {d}_{{k}_{i}} ⊙ {R}_{i - 1} ) ( {x}_{i} , {y}_{i} ) )}{{‖ {d}_{{k}_{i}} ‖}_{F}^{2}} , \qquad ( 24 )$$

where [symbol] _{τ}(α)=max{α−τ, 0} is the shrinkage thresholding operator and ⊙ is the correlation operator. We can then solve for the remaining variables in (23) by plugging in the expressions for \hat{α}ᵢ(xᵢ, yᵢ, kᵢ) and simplifying, which leads to:

$$( {\hat{x}}_{i} , {\hat{y}}_{i} , {\hat{k}}_{i} ) = {arg max}_{{x}_{i} {y}_{i} , {k}_{i}} [ \frac{{( ( {d}_{{k}_{i}} ⊙ {R}_{i - 1} ) ( {x}_{i} , {y}_{i} ) - \frac{{σ}_{I}^{2}}{η} )}^{2}}{{‖ {d}_{{k}_{i}} ‖}_{F}^{2}} + 2 {σ}_{I}^{2} log ( \frac{{μ}_{class ( {k}_{i} )}}{{t}_{class ( {k}_{i} )}} ) ] . \qquad ( 25 )$$

Note that although at first glance Equation (25) appears to be somewhat challenging to solve as it requires searching over all object locations and templates, the problem can, in fact, be solved very efficiently by employing a max-heap data structure and only making local updates to the max-heap at each iteration, as discussed in previous work.

### Cell Counting

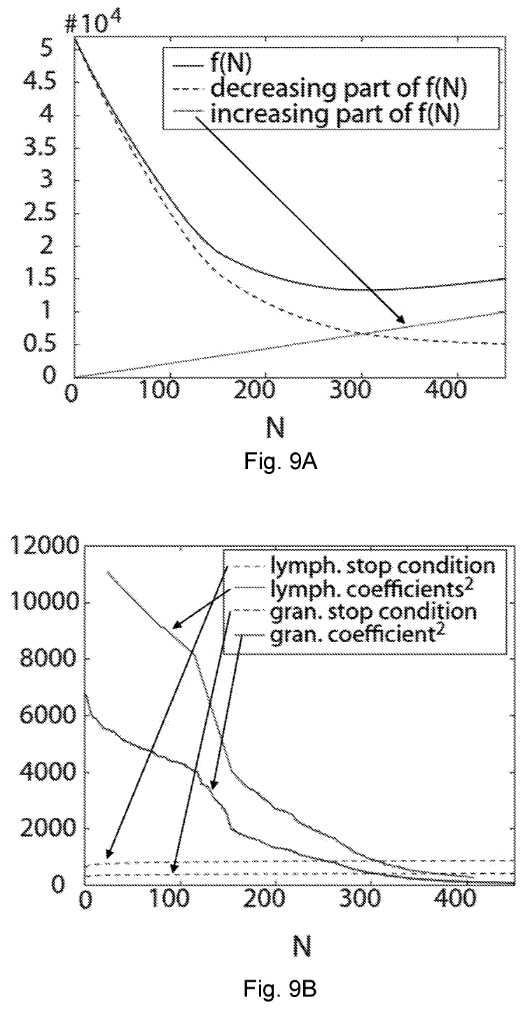

Cell counting amounts to finding the optimal value for the number of cells in the image, N in (21). The objective function for N, plotted in FIG. 9A, at each iteration is:

$$f ( N ) = \frac{{‖ {R}_{N} ‖}_{F}^{2}}{2 {σ}^{2}} + \frac{1}{η} {\sum }_{i = 1}^{N} {α}_{i} - {\sum }_{i = 1}^{N} log ( \frac{{μ}_{class ( {k}_{i} )}}{{t}_{class ( {k}_{i} )}} ) + N log ( \frac{η {P}_{I}}{λ} ) + log ( N ! ) . \qquad ( 26 )$$

Notice that in the expression for f(N), the residual's norm ∥R_{N}∥_{F}² should be decreasing with each iteration as cells are detected and removed from the residual image. Note also that αᵢ is positive, and μₛᵢ_{ᵢ}/tₛ_{ᵢ}<1, so assuming that ηP_{I}>λ (which is typically easily satisfied), all terms in the expression for f(N) except the residual term should be increasing with N. This suggests that we stop searching for cells when f(N) begins to increase, i.e., f(N)>f(N−1).

The above condition can be expressed as:

$$\frac{{α}_{N}}{η} - \frac{2 {R}_{N} ⊙ {d}_{{k}_{N}} {α}_{N} + {‖ {d}_{{k}_{N}} ‖}_{F}^{2} {α}_{N}^{2}}{2 {σ}_{I}^{2}} + log ( \frac{η {P}_{I} {Nt}_{{s}_{N}}}{λ {μ}_{{s}_{N}}} ) > 0. \qquad ( 27 )$$

### Moreover, if

$${R}_{N} ⊙ {d}_{{k}_{N}} \geq \frac{{σ}_{I}^{2}}{η}$$

it follows from (24) that

$${R}_{N} ⊙ {d}_{{k}_{N}} = {α}_{N} {‖ {d}_{{k}_{N}} ‖}_{F}^{2} + \frac{{σ}_{I}^{2}}{η} .$$

Substituting this into (27) leads to the following stopping criteria:

$${α}_{N}^{2} < \frac{2 {σ}_{I}^{2}}{{‖ {d}_{{k}_{N}} ‖}_{F}^{2}} log ( \frac{η {P}_{I} {Nt}_{{S}_{N}}}{λ {μ}_{{S}_{N}}} ) . \qquad ( 28 )$$

That is, we should stop cell counting when the square of the strength of the detection decreases below the stopping condition. Notice that the stopping condition is class-dependent, as both λ_{c} and t_{c}, will depend on which class c is selected to describe the N^{th} cell. Although the stopping criteria for different classes might not fall in the same range, the iterative process will not terminate until the detections from all classes are completed. For example, notice in FIG. 9B that although the coefficients for one class are larger than those for a second class, both cell classes reach their respective stopping conditions at around the same iteration.

The class-dependent stopping condition is a major advantage of the present model, compared to standard convolutional sparse coding. Indeed, notice that if the class proportion prior term is eliminated from (26), then the stopping criteria in (28) does not depend on the class because, without loss of generality, one can assume that the dictionary atoms are unit norm, i.e., ∥dₖ∥=1. As a consequence, the greedy procedure will tend to select classes with larger cells because they reduce the residual term ∥R_{N}∥_{F}² more. The present model alleviates this problem because when λ, is small, the threshold in (28) increases and so our method stops selecting cells from class c.

In summary, the greedy method described by Equations (22), (25) for detecting and classifying cells, together with the stopping condition in Equation (28) for counting cells give a complete method for doing inference in new images.

### Parameter Learning

In the previous section we described a method which may be used for inferring the latent variables, {α, k, x, N}, of the present generative convolutional model in (19) given an image I. However, before we can do inference on new images, we first learn the parameters {σ_{I}, {dₖ}ₖ₌₁^{K}, η, λ, {μ_{c}}_{c=1}^{C}} of the model. In typical object detection and classification models, this is usually accomplished by having access to training data which provides manual annotations of many of the latent variables (for example, object locations and object class). However, our application is uniquely challenging in that we do not have access to manual annotations, so instead we exploit using two datasets for learning our model parameters: (1) a complete blood count (CBC) database of approximately 300,000 patients of the Johns Hopkins hospital system, and (2) LFI images taken of cells from only one WBC subclass obtained by experimentally purifying a blood sample to isolate cells from a single subclass.

Population Parameters. First, to learn the model parameters that correspond to the expected number of cells and the proportions of the various subclasses we utilize the large CBC database, which provides the total number of WBCs as well as the proportion of each subclass of WBC (i.e., monocytes, granulocytes, and lymphocytes) for each of the approximately 300,000 patients in the dataset. From this, we estimate λ and {μ_{c}}_{c=1}^{C} as:

$$λ = \frac{1}{{J}_{c b c}} {\sum }_{j = 1}^{{J}_{c b c}} {N}^{j} , \\ {μ}_{c} = \frac{{Σ}_{j = 1}^{{J}_{c b c}} {n}_{c}^{j}}{{Σ}_{j = 1}^{{J}_{c b c}} {N}^{j}} \qquad ( 29 )$$

where J_{cbc}≈300,000 is the number of patient records in the dataset and (N^{j}, n_{c}^{j}) are the total number of WBCs and number of WBCs of class c, respectively, for patient j (appropriately scaled to match the volume and dilution of blood that we image with a LFI system).

Imaging Parameters. With these population parameters fixed, we are now left with the task of learning the remaining model parameters which are specific to the LFI images θ={σ_{I}, {dₖ}ₖ₌₁^{K}, η}. To accomplish this task, we employ a maximum likelihood scheme using LFI images of purified samples which contain WBCs from only one of the subclasses. Specifically, because the samples are purified we know that all cells in an image are from the same known class, but we do not know the other latent variables, so to use a maximum likelihood scheme, one needs to maximize the log likelihood with respect to the model parameters, θ, by marginalizing over the latent variables {α, k, x, N},

$$\hat{θ} = {arg max}_{θ} {\sum }_{j = 1}^{J} log p ( {I}^{j} ) = {arg max}_{θ} {\sum }_{j = 1}^{J} log ( Δ ) \\ Δ = {\sum }_{{k}^{j} , {N}^{j}} \int \int p ( {I}^{j} , {α}^{j} , {k}^{j} , {x}^{j} , {N}^{j} ) d {α}^{j} d {x}^{j} \qquad ( 30 )$$

where J denotes the number of images of purified samples.

However, solving for the \hat{θ} parameters directly from (30) is difficult due to the integration over the latent variables {α, k, x, N}. Instead, we use an approximate expectation maximization (EM) technique to find the optimal parameters by alternating between updating the latent variables, given the parameters and updating the parameters, given the latent variables. Specifically, note that the exact EM update step for new parameters θ, given current parameters \hat{θ} is:

$${θ}_{E M} = {arg max}_{θ} {\sum }_{j = 1}^{J} {\sum }_{{k}^{j} , {N}^{j}} \int \int [ {p}_{\hat{θ}} ( {α}^{j} , {k}^{j} , {x}^{j} , {N}^{j} \vert {I}^{j} ) log ( {p}_{θ} ( {I}^{j} , {x}^{j} , {N}^{j} , {α}^{j} , {k}^{j} ) ) ] d {α}^{j} d {x}^{j} , \qquad ( 31 )$$

which can be simplified by approximating with a delta function p_{\hat{θ}}(α, k, x, N|I)=δ(α−\hat{α}, k−\hat{k}, x−\hat{x}, N−\hat{N}), as in previous work, where:

$$( \hat{α} , \hat{k} , \hat{x} , \hat{N} ) = {arg max}_{α , k , x , N} {p}_{\hat{θ}} ( α , k , x , N \vert I ) \qquad ( 32 )$$

The above assumption leads to the approximation:

$${\hat{θ}}_{approx} = {arg max}_{θ} {\sum }_{j = 1}^{J} log {p}_{θ} ( {I}^{j} , {\hat{α}}^{j} , {\hat{k}}^{j} , {\hat{x}}^{j} , {\hat{N}}^{j} ) \qquad ( 33 )$$

Using this approximate EM framework, we then alternate between updating the latent variables given the old parameters and updating the parameters, given the latent variables:

$$\begin{matrix}( {\hat{α}}^{j} , {\hat{k}}^{j} , {\hat{x}}^{j} , {\hat{N}}^{j} ) = {arg min}_{{α}^{j} > 0 , {k}^{j {,}_{x} j} , {N}^{j}} & ( 34 ) \\ [ \frac{{‖ {I}^{j} - {\sum }_{i = 1}^{{N}^{j}} {\hat{d}}_{{k}_{i}^{j}} ★ {α}_{i}^{j} {δ}_{{x}_{i}^{j} , {y}_{i}^{j}} ‖}_{F}^{2}}{2 {\hat{σ}}_{I}^{2}} + \frac{{\sum }_{i = 1}^{{N}^{j}} {α}_{i}^{j}}{\hat{η}} + {N}^{j} log ( \frac{η {P}_{I}}{λ} ) + log ( {N}^{j} ! ) ] & \\ subject to class ( {k}_{i}^{j} ) = {s}^{j} ∀ ( i , j ) & \\ and & \\ {max}_{θ} {\sum }_{j = 1}^{J} [ - \frac{{‖ {I}^{j} - {\sum }_{i = 1}^{{N}^{j}} {\hat{α}}_{i}^{j} {d}_{{\hat{k}}_{i}^{j}} ★ {δ}_{{\hat{x}}_{i}^{j} , {\hat{y}}_{i}^{j}} ‖}_{F}^{2}}{2 {σ}_{I}^{2} ,} - \frac{{\sum }_{i = 1}^{{N}^{j}} {\hat{α}}_{i}^{j}}{η} - \frac{{P}_{I}}{2} log ( 2 {πσ}_{I}^{2} ) - {N}^{j} log ( {P}_{I} η ) ] & ( 35 )\end{matrix}$$

Note that the latent variable inference in (34) is equivalent to the inference described above except that because we are using purified samples we know the class of all cells in the image, s^{j}, so the prior p(k|N) is replaced by the constraint on the template classes.

Unfortunately, the optimization problem in Equation (35) that was obtained via approximation is not well defined, since the objective goes to infinity when η→0 and \hat{α}→0 with the norm of the templates, {dₖ}ₖ₌₁^{K}, going to ∞. To address these issues, we fix the signal to noise ratio (SNR) of

$$\frac{η}{{σ}_{I}^{2}}$$

to a constant and constrain the [symbol] ₁ norms of the templates to be equal to enforce that the mean value of a pixel for any cell is the same regardless of the class type. (In cases where the images are non-negative, the template update scheme will have templates that are also always non-negative. As a result the [symbol] ₁ norm is proportional to the mean pixel value of the template.) Subject to these constraints, we solve (35) for η and the templates by:

$$η = \frac{{\sum }_{j = 1}^{J} {\sum }_{i = 1}^{{N}^{j}} {\hat{α}}_{i}^{j}}{{\sum }_{j = 1}^{J} \hat{{N}^{j}}} , {d}_{l} = \frac{{\sum }_{( i j ) ∈ W} {z}_{i}^{j}}{{\sum }_{( i j ) ∈ W} {\hat{α}}_{i}^{j}} \qquad ( 36 )$$

where W={(i,j):\hat{k}ᵢ^{j}=l} and zᵢ^{j} is a patch with the same size as the templates, extracted from I^{j} centered at (\hat{x}ᵢ^{j}, ŷᵢ^{j}). The templates are then normalized to have unit [symbol] ₁ norm and σ_{I} is set based on the fixed signal-to-noise ratio,

$${σ}_{I}^{2} = \frac{η}{S N R} ,$$

where the SNR is estimated as the ratio of [symbol] ₂ norms between background patches of the image and patches containing cells. Note that because all of the dictionary updates decouple by training image and each training image contains only one cell class, our procedure is equivalent to learning a separate dictionary for each cell class independently.

In some embodiments, a system for detecting, classifying, and/or counting objects in a specimen and/or an image of a specimen is provided. The system may include a chamber for holding at least a portion of the specimen. The chamber may be, for example, a flow chamber. A sensor, such as a lens-free image sensor, is provided for obtaining a holographic image of the portion of the specimen in the chamber. The image sensor may be, for example, an active pixel sensor, a CCD, a CMOS active pixel sensor, etc. In some embodiments, the system further includes a coherent light source. A processor is in communication with the image sensor. The processor is programmed to perform any of the methods of the present disclosure. In some embodiments, the present disclosure is a non-transitory computer-readable medium having stored thereon a computer program for instructing a computer to perform any of the methods disclosed herein.

The processor may be in communication with and/or include a memory. The memory can be, for example, a Random-Access Memory (RAM) (e.g., a dynamic RAM, a static RAM), a flash memory, a removable memory, and/or so forth. In some instances, instructions associated with performing the operations described herein (e.g., operate an image sensor, generate a reconstructed image) can be stored within the memory and/or a storage medium (which, in some embodiments, includes a database in which the instructions are stored) and the instructions are executed at the processor.

In some instances, the processor includes one or more modules and/or components. Each module/component executed by the processor can be any combination of hardware-based module/component (e.g., a field-programmable gate array (FPGA), an application specific integrated circuit (ASIC), a digital signal processor (DSP)), software-based module (e.g., a module of computer code stored in the memory and/or in the database, and/or executed at the processor), and/or a combination of hardware- and software-based modules. Each module/component executed by the processor is capable of performing one or more specific functions/operations as described herein. In some instances, the modules/components included and executed in the processor can be, for example, a process, application, virtual machine, and/or some other hardware or software module/component. The processor can be any suitable processor configured to run and/or execute those modules/components. The processor can be any suitable processing device configured to run and/or execute a set of instructions or code. For example, the processor can be a general purpose processor, a central processing unit (CPU), an accelerated processing unit (APU), a field-programmable gate array (FPGA), an application specific integrated circuit (ASIC), a digital signal processor (DSP), and/or the like.

Some instances described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other instances described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, instances may be implemented using Java, C++, .NET, or other programming languages (e.g., object-oriented programming languages) and development tools. Additional examples of computer code include, but are not limited to, control signals, encrypted code, and compressed code.

### Results of Second Illustrative Example

The presently-disclosed cell detection, counting and classification method was tested on reconstructed holographic images of lysed blood, which contain three sub-populations of WBCs (granulocytes, lymphocytes and monocytes) as well as lysed red blood cell debris, such as the image shown in FIGS. 7A and 7B. The recorded holograms were reconstructed into images using a sparse phase retrieval method, and the absolute value of the complex reconstructed image was used for both training and testing.

### Training Results

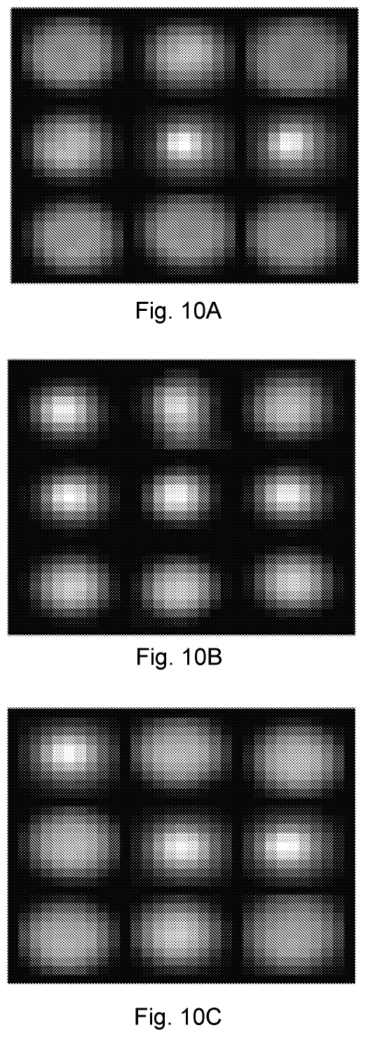

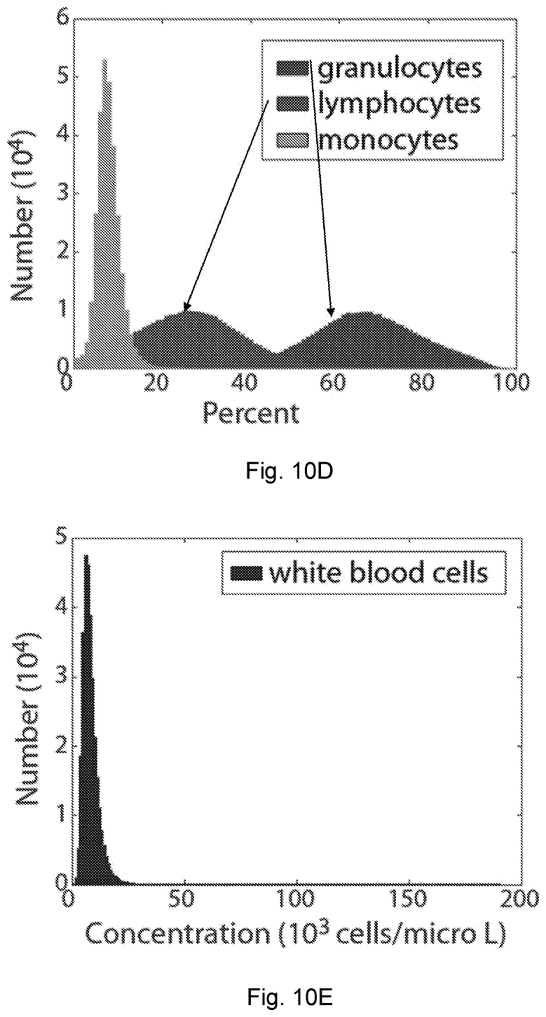

Using the purified cell images, we learned the templates shown in FIGS. 10A-10C. Notice that the lymphocyte templates are smaller than the granulocyte and monocyte templates, consistent with what is known about WBCs. The templates have low resolution due to the low resolution, large field of view images obtained with lens-free imaging. To learn the prior class proportions and the mean number of cells per image, we utilize the database of CBC results. FIGS. 10D-10E shows histograms of the class proportions of granulocytes, lymphocytes, and monocytes, in addition to a histogram of the total WBC concentrations, from the CBC database.

### Detection, Counting, and Classification Results

Cell detection, counting, and classification with an embodiment of the present method was tested on a dataset consisting of lysed blood for 32 donors. The blood comes from both healthy volunteer donors and clinical discards from hospital patients. The clinical discards were selected for having abnormal granulocyte counts, which often coincides with abnormal lymphocyte, monocyte, and WBC counts as well due to various pathologies. We were therefore able to test the presently-disclosed method on both samples that are well described by the mean of the probability distribution of class proportions as well as samples that lie on the tail of the distribution.

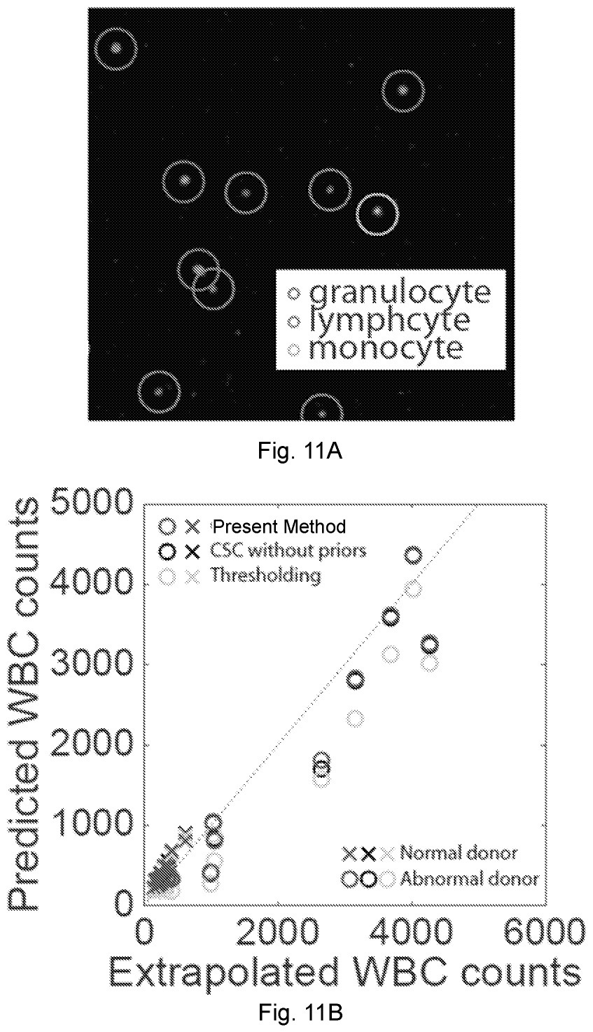

The presently-disclosed method shows promising results. FIG. 11A shows a small region of an image overlaid with detections and classifications predicted by an embodiment of the present method. Because we lack ground truth detections and classifications for individual cells in our testing data, we turn to counting and classification results for cell populations to evaluate performance of the instant method. Each donor's blood was divided into two parts—one part was imaged with a lens-free imager to produce at least 20 images, and the other portion of blood was sent for analysis in a standard hematology analyzer. The hematology analyzer provided ground truth concentrations of WBCs and ground truth cell class proportions of granulocytes, lymphocytes, and monocytes for each donor. By estimating the volume of blood being imaged and the blood's dilution in lysis buffer, we extrapolated ground truth WBC counts per image from the known concentrations.

A comparison of the cell counts obtained by the present method and the extrapolated counts obtained from the hematology analyzer is shown in FIG. 11B. Note that all of the normal blood donors have under 1000 WBCs per image, while the abnormal donors span a much wider range of WBC counts. Observe there is a clear correlation between the counts from the hematology analyzer and the counts predicted by the present method. Also note that errors in estimating the volume of blood being imaged and the dilution of blood in lysis buffer could lead to errors in the extrapolated cell counts.

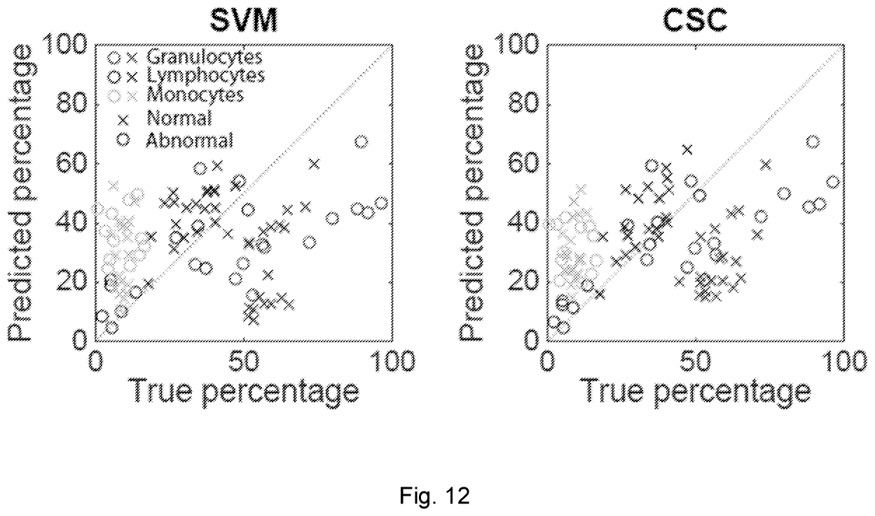

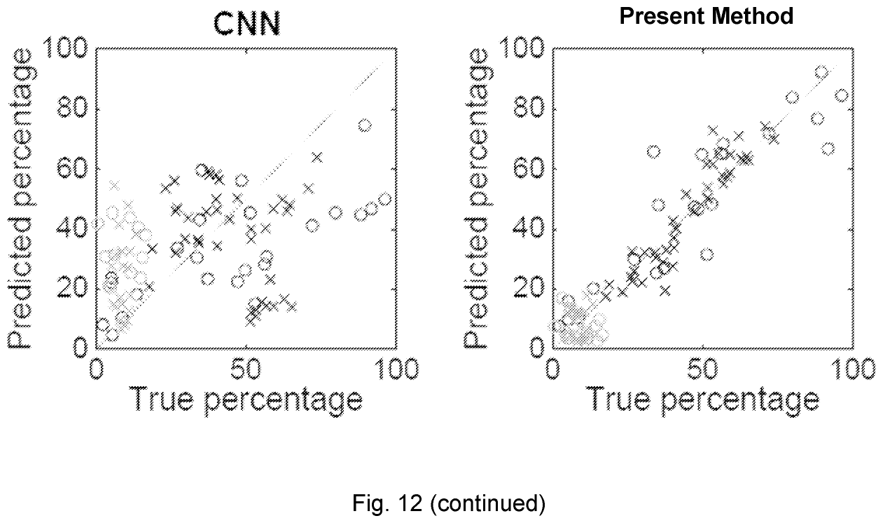

FIG. 12 (bottom right) shows a comparison between the class proportion predictions obtained from the present method and the ground truth proportions for both normal and abnormal blood donors. As before, we do not have ground truth for individual cells, but for the entire blood sample. Notice once again that the abnormal donors span a much wider range of possible values than do the normal donors. For example, normal donors contain at least 15% lymphocytes, but abnormal donors contain as few as 2% lymphocytes. Despite abnormal donors having WBC differentials widely varying from the distribution mean learned by our model, we are still able to predict their differentials with promising accuracy. Finally, note that WBC morphology can vary from donor to donor, especially among clinical discards. Having access to more purified training data from a wider range of donors would likely improve our ability to classify WBCs.

### Comparison with Other Methods

To quantify the present method, we compare the counting and classification ability of our method to standard convolutional sparse coding (CSC) without priors as described in previous work, as well as to support vector machine (SVM), and convolutional neural networks (CNN) classifiers. The SVM and CNN algorithms operate on extracted image patches of detected cells, where the cells were detected via thresholding, filtering detections by size (i.e., discarding objects that were smaller or larger than typical cells).

FIG. 11B shows the counting results and FIG. 12 shows the classification results obtained by the various methods. Templates used for CSC without priors are trained from purified WBC populations, and the class assigned to each detected cell corresponds to the class of the template that best describes that cell. In terms of total WBC counts, standard CSC performs similarly to the present method. This is not surprising, as both methods iteratively detect cells until the coefficient of detection falls beneath a threshold. However, an important distinction is that with standard CSC this threshold is selected via a cross validation step, while in the present method the stopping threshold is provided in closed form via (28). Likewise, simple thresholding also achieves very similar but slightly less accurate counts compared to the convolutional encoding methods.

Although in simply counting the number of WBCs per image, the various methods all perform similarly, a wide divergence in performance is observed in how the methods classify cell types as can be seen in the classification results in Table 1. CSC without a statistical model for the class proportions is unable to reliably predict the proportions of granulocytes, lymphocytes, and monocytes in an image, while the present method does a much better job. For only normal donors, the present method is able to classify all cell populations with absolute mean error under 5%, while standard CSC mean errors are as large as 31% for granulocytes. For the entire dataset, which contains both normal and abnormal blood data, the present method achieves on average less than 7% absolute error, while the standard CSC method results in up to 30% average absolute error.

TABLE 1
Mean absolute error between ground truth and predicted results for
classification are shown for only normal donors and for all donors.

| Mean Absolute Error | Ours | CSC | SVM | CNN |
|---|---|---|---|---|
| Granulocytes - normal | 4.5 | 31.1 | 31.6 | 27.8 |
| Lymphocytes - normal | 4.6 | 9.5 | 11.1 | 12.8 |
| Monocytes - normal | 4.7 | 21.9 | 20.4 | 15.9 |
| Granulocytes - all | 6.8 | 30.1 | 31.8 | 28.6 |
| Lymphocytes - all | 5.6 | 8.3 | 10.1 | 11.6 |
| Monocytes - all | 5.5 | 22.3 | 22.8 | 18.9 |

Classification results for the three WBC classes are shown for our proposed method, CSC, SVM, and CNN. Note results are for population proportions.

In addition to standard CSC, we also used the cell detections from thresholding to extract cell patches centered at the detections and then classified the extracted cell patches using both a support vector machine (SVM) and a convolutional neural network (CNN). The SVM performed a one-versus-all classification with a Gaussian kernel using cell patches extracted from the images taken from purified samples to train the SVM. Additionally, we implemented a CNN similar to that described in previous work. Specifically, we kept the overall architecture but reduced the filter and max-pooling sizes to account for our smaller input patches, resulting in a network with three convolutional layers fed into two fully-connected layers with a max-pooling layer between the second and third convolutional layer. Each convolutional layer used ReLU non-linearities and a 3×3 kernel size with 6, 16, and 120 filters in each layer, respectively. The max-pooling layer had a pooling size of 3×3, and the intermediate fully-connected layer had 84 hidden units. The network was trained via stochastic gradient descent using the cross-entropy loss on 93 purified cell images from a single donor. Note that the CNN requires much more training data than our method, which requires only a few training images.

Both the SVM and CNN classifiers perform considerably worse than the presently-disclosed method, with the SVM producing errors up to 32%. The CNN achieves slightly better performance than the SVM and standard CSC methods, but errors still reach up to 29%.

Although the present disclosure has been described with respect to one or more particular embodiments, it will be understood that other embodiments of the present disclosure may be made without departing from the spirit and scope of the present disclosure.

What is claimed is:

1. A method for classifying a population of objects based on a template dictionary and class proportion data, comprising:
obtaining an image having one or more objects depicted therein;
determining a total number (N) of objects in the image;
obtaining class proportion data and a template dictionary comprising at least one object template of at least one object class;
extracting one or more image patches (eᵢ), each image patch of the one or more image patches containing a corresponding object (i) of the image; and
determining a class of each object based on a strength of match (αᵢ) of the corresponding image patch (eᵢ) to each object template and influenced by the class proportion data.

2. The method of claim 1, wherein the image is a holographic image.

3. The method of claim 1, wherein the strength of match is determined according to αᵢ(kᵢ)=dₖ_{ᵢ}^{T}eᵢ, where i is the object, dₖ_{ᵢ} is an image of the kᵢ^{th} object template, and eis the image patch corresponding to the i^{th} object.

4. The method of claim 1, wherein the class of each object is influenced by a probability p_{c|N} that an object is in class c given a total number N of objects, and wherein the probability p_{c|N} is based on the class proportion data.

5. The method of claim 1, wherein the class proportion data is weighted by a pre-determined value (λ).

6. The method of claim 1, wherein an index (k) of the object template of each object (i) is determined according to
$${k}_{i} = {arg max}_{j ∈ 1 : K} [ {( {d}_{j}^{T} {e}_{i} )}^{2} + λ {\sum }_{c = 1}^{C} 1 ( class ( {d}_{j} ) = c ) log {p}_{c \vert N} ] ,$$
where d ⱼ is an image of the j^{th} object template, K is a total number of object templates, eᵢ is the image patch corresponding to the i^{th} object, c is a class, C is a total number of classes, dⱼ is an image of the j^{th} object template, and p_{c|N} is a probability that an object is in class c given a total number N of objects, and λ is a pre-determined weight value.

7. The method of claim 6, wherein the proportion of class c is determined according to
$$\frac{{n}_{c}}{N} ,$$
where N is the total number of objects, n_{c}=Σᵢ₌₁^{N}1(class(dₖ_{ᵢ})=c) is a number of objects belonging to class c, dₖ_{ᵢ} is an image of the ᵢ^{th} object template.

8. The method of claim 1, wherein the template dictionary includes image templates for one or more of monocytes, lymphocytes, and granulocytes.

9. A system for classifying objects in a specimen, the system comprising:
a chamber for holding at least a portion of the specimen;
an image sensor for obtaining an image of the portion of the specimen in the chamber; and
a processor in communication with the image sensor, the processor programmed to:
obtain an image having one or more objects depicted therein;
determine a total number (N) of objects in the image;
obtain class proportion data and a template dictionary comprising at least one object template of at least one object class;
extract one or more image patches (eᵢ), each image patch of the one or more image patches containing a corresponding object (i) of the image; and
determine a class of each object based on a strength of match (αᵢ) of the corresponding image patch (eᵢ) to each object template and influenced by the class proportion data.

10. The system of claim 9, wherein the processor is programmed to determine the strength of match according to αᵢ(kᵢ)=dₖ_{ᵢ}^{T}eᵢ, where i is the object, dₖ_{ᵢ} is an image of the kᵢ^{th} object template, and eᵢ is the image patch corresponding to the i^{th} object.

11. The system of claim 9, wherein the class of each object is influenced by a probability p_{c|N} that an object is in class c given a total number N of objects, and wherein the probability p_{C|N} is based on the class proportion data.

12. The system of claim 9, wherein the processor is programmed to weight the class proportion data by a pre-determined value (λ).

13. The system of claim 9, wherein the processor is programmed to determine an index (k) of each object (i) according to
$${k}_{i} = {arg max}_{j ∈ 1 : K} [ {( {d}_{j}^{T} {e}_{i} )}^{2} + λ {\sum }_{c = 1}^{C} 1 ( class ( {d}_{j} ) = c ) log {p}_{c \vert N} ] ,$$
where dⱼ is an image of the j^{th} object template, K is a total number of object templates, eᵢ is the image patch corresponding to the i^{th} object, c is a class, C is a total number of classes, dⱼ is an image of the j^{th} object template, and p_{c|N} is a probability that an object is in class c given a total number N of objects, and λ is a pre-determined weight of the class proportion.

14. The system of claim 13, wherein the processor is programmed to determine a proportion of class c according to
$$\frac{{n}_{c}}{N} ,$$
where N is the total number of objects, n_{c}=Σᵢ₌₁^{N}1(class(dₖ_{ᵢ})=c) is a number of objects belonging to class c, dₖ_{ᵢ} is an image of the kᵢ^{th} object template.

15. The system of claim 9, wherein the template dictionary includes image templates for one or more of monocytes, lymphocytes, and granulocytes.

16. The system of claim 9, wherein the chamber is a flow chamber.

17. The system of claim 9, wherein the image sensor is an active pixel sensor, a CCD, or a CMOS active pixel sensor.

18. The system of claim 9, wherein the image sensor is a lens-free image sensor for obtaining holographic images.

19. The system of claim 9, further comprising a coherent light source.

20. A non-transitory computer-readable medium having stored thereon a computer program for instructing a computer to:
obtain a holographic image having one or more objects depicted therein;
determine a total number (N) of objects in the image;
obtain class proportion data and a template dictionary comprising at least one object template of at least one object class;
extract one or more image patches (eᵢ), each image patch containing a corresponding object (i) of the image; and
determine a class of each object based on a strength of match (αᵢ) of the corresponding image patch (eᵢ) to each object template and influenced by the class proportion data.
